(19) United States
(12) Patent Application Publication
(10) Pub. No.: US 2014/0246803 A1
(43) Pub. Date: Sep. 4, 2014

(54) METHOD FOR PRODUCING A FRAME FOR AN ENGINE COOLING FAN OF A MOTOR VEHICLE

(71) Applicant: Robert Bosch GmbH, Stuttgart (DE)

(72) Inventors: Thomas Helming, Shanghai (CN); Andreas Ewert, Lichtenau (DE); Markus Liedel, Waltham, MA (US)

(73) Assignee: Robert Bosch GmbH, Stuttgart (DE)

(21) Appl. No.: 14/351,600

(22) PCT Filed: Oct. 2, 2012
(86) PCT No.: PCT/EP2012/069398

§ 371 Date: Apr. 14, 2014

(30) Foreign Application Priority Data
Oct. 14, 2011 (DE) 10 2011 084 498.8

(51) Int. Cl. B29C 45/14

(52) U.S. Cl. CPC B29C 45/14467; B29C 45/14754
USPC 264/242

(57) ABSTRACT

Equipping engine cooling fans with flaps, in particular ram-air flaps, which are opened by the relative wind and can close again by means of gravity at a vehicle standstill, is known. Until know, it has been common to install such ram-air flaps manually on a frame of the engine cooling fan. However, all of said embodiment concepts require complex motion guidance during the installation in/on the frame. The invention relates to a method for producing a frame (1) for an engine cooling fan of a motor vehicle in order to provide economical automation, the frame being equipped with a flap (5), in particular ram-air flap, and produced by means of injection molding in a tool (16), wherein an articulated connection of the flap (5) to the frame (1) is provided in a joint production step for the frame (1), in which the flap (5) is first prepositioned in the tool (16) for the production of the frame (1) and then provided cavities (10) of the flap (5) are also filled during the production of the frame (1), which cavities form corresponding bearing points (11) for the flap (5) on the frame (1) after the solidification of the plastic and thus enable a movable connection of the flap (5) to the frame (1). The invention is intended for frames having ram-air flaps for engine cooling fans of motor vehicles.

### BACKGROUND OF THE INVENTION

The present invention relates to a method for producing a frame for an engine cooling fan of a motor vehicle, the frame being equipped with a flap and being produced by means of injection molding in a tool.

Equipping engine cooling fans with flaps, in particular ram-air flaps, which are opened by the relative wind and can close again by means of gravity at a vehicle standstill, is known. Until now, it has been common to install such ram-air flaps manually on a frame of the engine cooling fan. The ram-air flaps can, for example, be clipped onto bearing pins. Elastomer ram-air flaps can alternatively be fastened via a type of snap-on connection or slip-on rails to the frames. All of said embodiment concepts require however complex motion guidance during the installation in/on the frame. An economical automation has not yet been possible. The installation of the ram-air flaps within the cycle time of the frame injection molding process is usually performed by a worker who is required to visually check the frames and also to package the same. If a plurality of ram air-flaps is to be installed, a plurality of people is therefore also required for installation. It is possible by means of technological developments to reduce the cycle time during the frame injection molding process. As a result of the reduced cycle time, it is, however, no longer possible for one person to install even a few ram-air flaps within the injection molding process. An additional person is required and the cost reduction potential by means of the reduction in injection molding time can not be completely utilized.

### SUMMARY OF THE INVENTION

The method according to the invention for producing a frame for an engine cooling fan of a motor vehicle has in contrast the advantage that an automated installation of ram-air flaps is facilitated by means of assembly injection molding. Within an injection molding process for the frame, all or a certain number of ram-air flaps can be automatically fastened. A cost reduction potential resulting from future cycle time reduction during injection molding of the frames can therefore be completely utilized in the future. It is furthermore very advantageous that sources of error can be reduced by the automated installation, which sources of error could occur or cause the process to be improperly implemented during manual installation.

A good connection of the flap to the frame results if a cavity, which is of conical configuration, is provided on each lateral face.

In order to prevent jamming, particularly due to material shrinkage during injection molding, it is proposed to improve the situation that the flap be configured having corrugated end faces which can be pulled flat during the positioning process in the tool.

A reliable and simple process results if the flap is constructed entirely from a flexible region or from at least two regions, a flexibly configured region and a rigidly configured region. It is thereby advantageous to produce the flexible region from an in particular thermoplastic elastomer, silicone or a fabric or a fabric tape. It is further advantageous to produce the rigid region from a fiber glass and/or mineral-reinforced plastic.

In order to improve the connection between flap and frame, the flexible region can be equipped with fastening elements.

In order to facilitate a simple production, it is advantageous to flexibly configure and partially extrusion coat only one base element, wherein the base element has a T-shape consisting of a longitudinal element and a transverse element.

A reliable and simple method results if the flexible base element of the flap is produced in particular from a thermoplastic elastomer, silicone or a fabric or a fabric tape.

A reliable and simple method results if different plastics are selected for producing the frame and the flap, which plastics prevent their welding together during the injection molding process.

### BRIEF DESCRIPTION OF THE DRAWINGS

Exemplary embodiments of the invention are explained in detail in the following description and further clarified with the aid of the drawings.

In the drawings:

FIG. 1 shows a ram-air flap pursuant to a first exemplary embodiment according to the invention prior to assembly injection molding of a frame;

FIG. 2 shows the ram-air flap pursuant to FIG. 1 fastened to or in a cover of the frame after assembly injection molding has been performed;

FIG. 3 shows a view of a tool with an inserted ram-air flap and abutment surfaces indicated by hatching;

FIG. 4 shows a ram-air flap equipped with a stop;

FIG. 5 shows an additional opening equipped with a stop;

FIG. 6 shows a ram-air flap designed with an offset and the tool associated therewith;

FIG. 7 shows a ram-air flap comprising rib and mandrel;

FIG. 8 shows a ram-air flap pursuant to a second exemplary embodiment according to the invention prior to assembly injection molding of a frame;

FIG. 9 shows the ram-air flap fastened to or in a cover of the frame after assembly injection molding has been performed pursuant to FIG. 8;

FIG. 10 shows a ram-air flap pursuant to the second exemplary embodiment according to the invention in an embodiment modified with respect to FIG. 8 prior to assembly injection molding;

FIG. 11 shows the ram-air flap according to FIG. 10 that is fastened to or in a cover of the frame after assembly injection molding has been performed;

FIG. 12 shows an individually depicted, flexible base element for the ram-air flap in the depiction on the left side, and the ram-air flap that is injection molded in a finished state on the frame in the depiction on the right side;

FIG. 13 shows an injection molding tool for producing the ram-air flap pursuant to FIG. 12 in the depiction on the left side and the associated flexible base element in the depiction on the right side; and

FIG. 14 shows a depiction of the fully manufactured ram-air flap in the frame opening or additional opening thereof.

### DETAILED DESCRIPTION

When attached to a radiator of an internal combustion engine, cooling fans are provided in order to ensure a sufficient cooling of the internal combustion during operation. The cooling fan or air-cooling fan usually covers the air inlet surface of the radiator and has a frame 1 which is partially shown in FIG. 2 and is furnished with fastening elements, which are not depicted in detail, in order to be able to fasten the same and thus the cooling fan to the radiator or to the body of the motor vehicle. The frame 1 usually comprises a cover 2; thus enabling air to only flow through a round fan opening, which is not shown in detail, in the cover 2 to fan blades of the cooling fan. One or a plurality of ram-air flaps 5 can be provided in the cover 2 of the frame 1. Said flaps are free to move and are opened by the relative wind and closed again by means of gravity at a vehicle standstill. It is thereby possible to optimize the engine cooling and to implement a thermal management of the engine. The ram air-flaps 5 open additional openings 6 in the cover 2 of the frame, for example, when the vehicle is being driven at higher speeds, whereat the relative wind provides for the cooling and the cooling fan is switched off; thus enabling regions covered by the cover 2 of the frame 1 to also be cooled by the relative wind. At lower vehicle speeds and high engine output, an obstruction or a more or less available closing position of the additional openings 6 in the cover 2 is useful in order to ensure an optimal ventilation of the radiator by means of the activated cooling fan.

The installation of the ram-air flaps is however complex so that an assembly injection molding process is proposed according to the invention in which the ram-air flap 5 is automatically attached to the frame 1 or, respectively, to the cover 2 during the frame injection molding process. The frame 1 as well as the cover 2 and the ram-air flap 5 consist of plastic and are formed in an injection molding process.

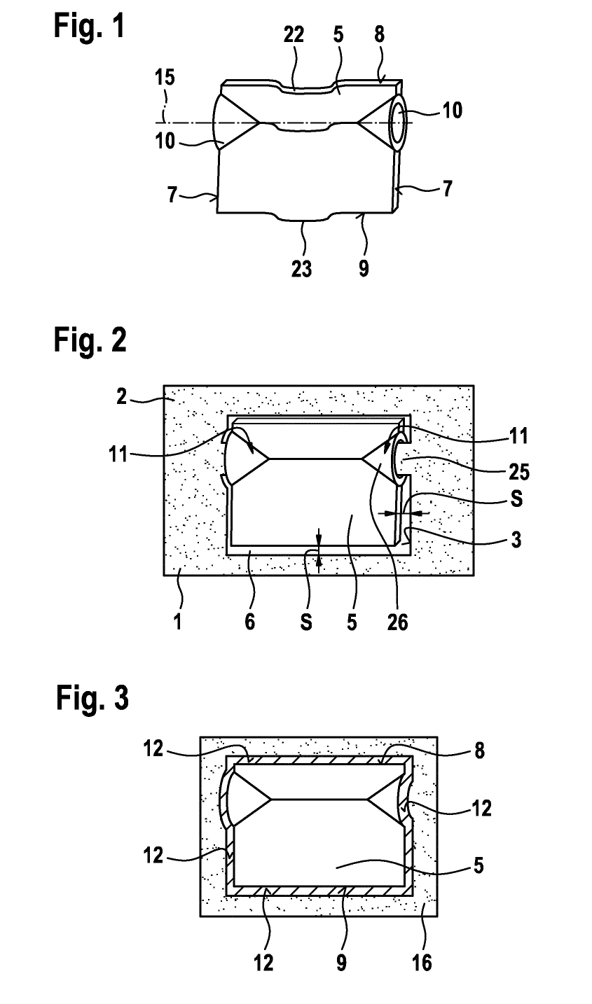

According to a first exemplary embodiment, the ram-air flap 5, as shown in FIG. 1, has a special geometric configuration. The ram-air flap 5 has a rectangular shape, wherein a conical recess 10 is provided in the ram-air flap 5 on each, for example, shorter lateral face 7, wherein the apexes of the cone lie internally on a common line parallel to an upper end face 8 or top side of the ram-air flap 5. After the recesses 10 have been molded, said line constitutes a subsequent rotational axis 15 or pivot axis for the ram-air flap 5. As FIG. 3 depicts in detail a view of a tool 16 comprising an inserted ram-air flap 5, said ram-air flap 5 is bordered laterally of the lateral faces 7 and at the upper end face 8 and a lower end face 9 or bottom surface by special abutment surfaces or sealing surfaces in the tool 16, which are depicted by cross-hatching. The tool 16 relates to an injection molding tool of known design which consists of two halves and the cavities provided therein are filled with plastic. Said abutment surfaces 16 or sealing surfaces in the tool 16 ensure the required clearances at the sides, top and bottom of the ram-air flap 5 during the subsequent injection molding process and eventual solidification process.

The ram-air flap 5 produced in a preceding injection molding process is inserted into the tool 16 for the frame 1 and with the cavities or the two lateral recesses 10 thereof is extrusion coated in such a manner that a movable hinge later results. With regard to material, suitable material combinations which cannot weld with one another are to be used for the ram-air flap 5 and the frame 1. Said material combinations include, for example, a PP (polypropylene) compound in combination with a PA (polyamide) compound. An articulated connection of the ram-air flap 5 to the frame 1 takes place in a joint production step for the frame 1. This results from the ram-air flap 5 being first prepositioned or inserted in the tool 16 for the production of the frame 1 and from the cavities 10 in the ram-air flap 5 which are provided laterally on both sides being subsequently filled during the production of the frame 1. After the solidification of the plastic and the removal of the tool 16, corresponding bearing points 11 for the ram-air flap 5 on the frame 1 are then formed, said points consisting of a cylindrical part 25 and a conical part 26 situated in the ram-air flap 5. The cylindrical part 26 originates at the frame 1 or a frame inside edge 3 or, respectively, an inside edge of the additional opening 6 and ends with the conical part 25. A movable hinge connection between frame 1 and ram-air flap 5 is formed by means of the bearing points 11.

In order to prevent the ram-air flap 5 from jamming due, for example, to material shrinkage during joint injection molding, provision is made for at least one of the end faces 8; 9 or both end faces 8, 9 of the ram-air flap 5 to be corrugated in design, i.e. being configured with depressions/indentations 22 or, respectively, elevations/protrusions, as is depicted in FIG. 1. If the corrugated ram-air flap 5 is inserted into the tool 16 and said tool 16 closes, the ram-air flap 5 is pressed “flat” and elongates in such a manner that the corrugation disappears and the end faces 8; 9 are again planar. The elongation performed when the tool closes is elastic. After extrusion coating the ram-air flap 5 in the elongated position, the tool 16 is opened again. As a result, the ram-air flap 5 can again partially contract elastically together and a certain clearance S remains within the bearing support by means of the conical, partially cylindrical bearing points 11 originating at the frame 1. All of this ensures a low force deflection capability of the ram-air flap 5 after the injection molding process.

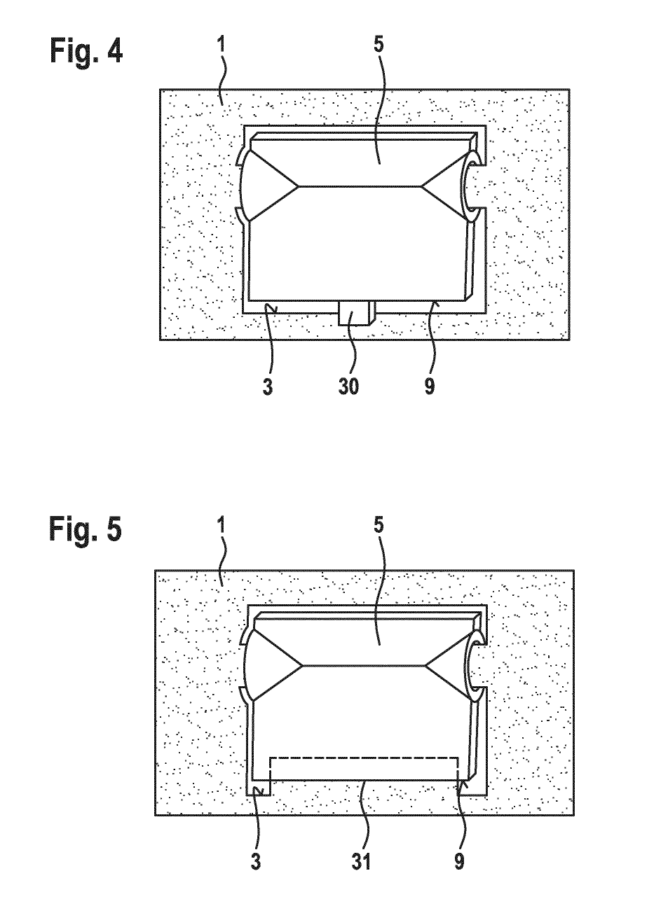

In order to be able to limit the rotation of the ram-air flap 5 about the rotational axis 15 or pivot axis, stops 30; 31 can be provided on the ram-air flap 5 or on the frame 1, respectively in the additional opening 6. The stops 30; 31 can be injection molded onto the aforementioned parts during the injection molding process. It is advantageous to extrusion coat the ram-air flap 5 in the tool 16 in a deflected position so that said ram-air flap 5 can first close after removal from the injection molding tool 16. The stops 30; 31 can furthermore reduce the leakage flow at the ram-air flap 5. As is shown in FIG. 4, the lower end face 9 of the ram-air flap 5 can have, for example, a rectangularly configured stop 30 in the center of said lower end face 9, which stop protrudes beyond an inner edge 3 of the frame 1; thus enabling said stop 30 to abut against the frame when the ram-air flap 5 is in the closed position. It is, however, also possible, as shown in FIG. 5, to equip the inner edge 3 itself with a, for example, rectangular stop 31 so that the inner edge 3 assumes a stepped form. The ram-air flap 5 can then strike in the region of the stop-free lower end face 9 thereof against the stop 31 of the frame 1. It is also possible, to subsequently mount said stops 30; 31 to the ram-air flap 5 or to the inner edge 3 of the additional opening 6 of the frame 1 as a separate part.

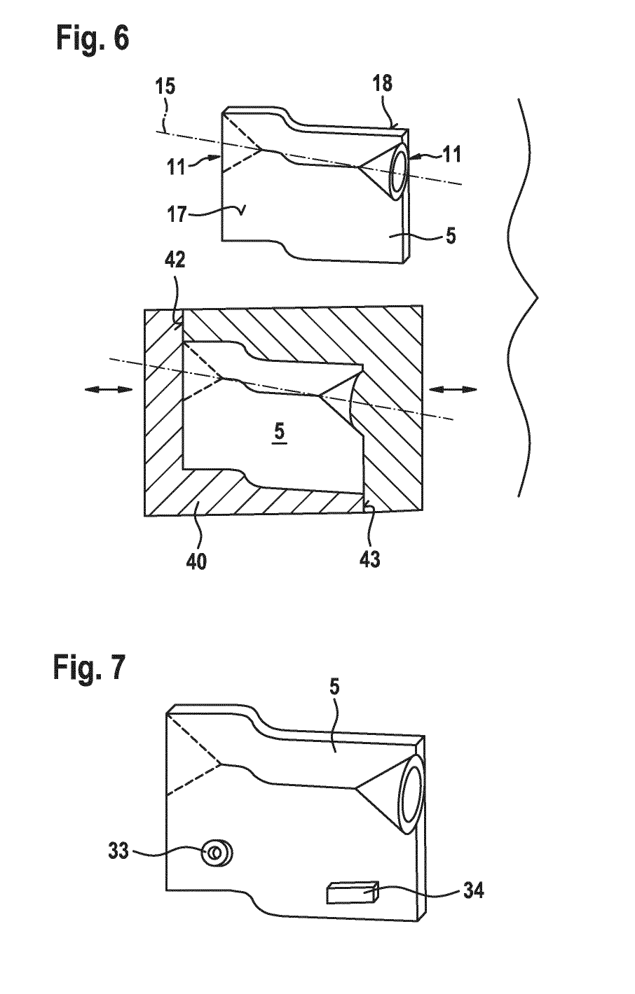

During assembly injection molding, separately molded individual parts are not put together by means of welding or other joining procedures but are joined to one another in a positive-locking and permanent manner with the same base material in a single injection process. In the exemplary embodiment, the prefabricated ram-air flap 5 is connected permanently but pivotably to the frame 1 or a part 2 of the frame 1 during the injection process for said frame 1. FIG. 6 shows a ram-air flap 5 which is optimally produced for this purpose and does not require a tool slide during injection molding. This facilitates a cost effective manner of production and can be achieved by a level jump as is shown in the upper depiction of the ram-air flap 5 in FIG. 6. The two bearing points 11 are oriented offset to one another; thus enabling a corrugated shape of a front face 17 or a rear face 18 of the ram-air flap 5 to be provided with a certain offset. This can, as is shown in the lower depiction in FIG. 6, take place using two tools 40, 41 which are separated from one another and meet at two tool joint faces 42, 43 and demonstrate the principle of tool separation when producing the individual ram-air flap part 5.

As is shown in FIG. 7, the ram-air flap 5 can also additionally be embodied with an integrated positioning mandrel 33 and with a rib 34 for an improved positional alignment. Besides ribs and mandrels, apertures can also be provided in the ram-air flap, which apertures facilitate a simplified accommodation by means of the handling device and positioning in the tool 16.

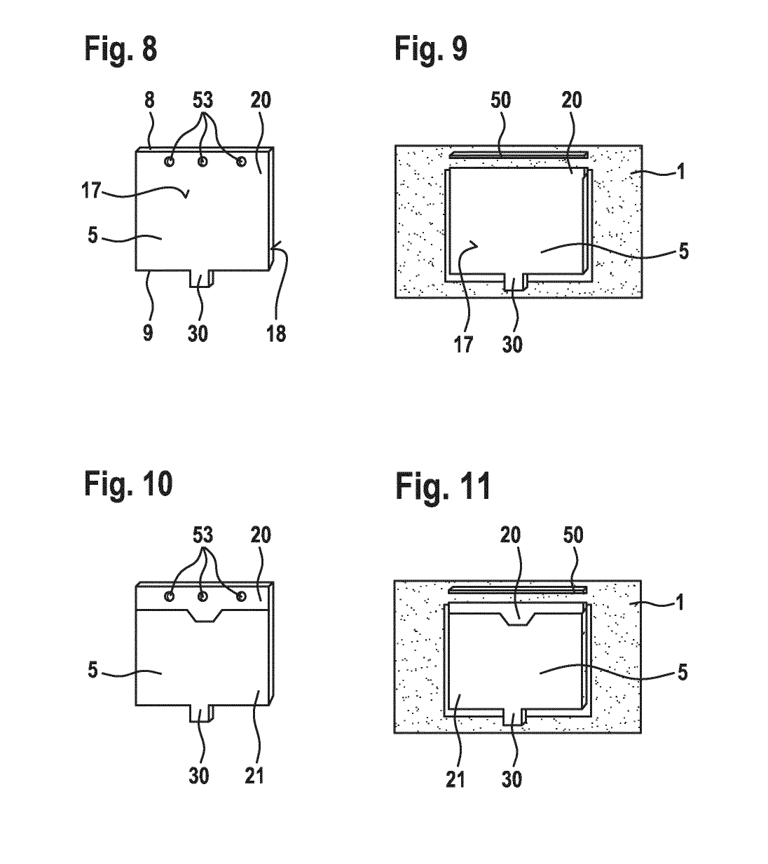

FIGS. 8 to 11 show a second exemplary embodiment of the method according to the invention in which all like or similarly operating components are denoted with the same reference numerals of the first exemplary embodiment. Instead of the two bearing points 11 pursuant to FIGS. 1 to 7, provision is now made to partially extrusion coat at least one region of the ram-air flap 5 which is flexibly configured in certain areas in order to thus obtain a movable hinge. As shown in FIG. 8, a flexible, single-component ram-air flap 5 can thus be used, said flap being continuously flexible. For this purpose, an elastomer, silicone or thermoplastic elastomers TPE can be used. The ram-air flap 5 is inserted into the injection molding tool and together with the frame 1 is partially extrusion coated. The extrusion coating takes place in an upper region 20 of the ram-air flap 5, for example in the first fifth of said ram-air flap 5, i.e., as viewed originating at the upper end face 8 in the direction of the lower end face 9, approximately ⅕ of the length of the lateral face 7; 8. For example, a slot 50 can also be left out from extrusion coating so that a type of strap 51 for holding the ram-air flap 5 is formed respectively on both sides of the front face 17 and the rear face of said ram-air flap 5 and exposes the upper end face 8. Additional, for example three, fastening elements 53 can also be provided in the upper region 20 of the ram-air flap 5 for supporting the bracket in the frame 1. The fastening elements 53 can be designed in the form of apertures which, then filled with plastic of the frame 1, produce an improved connection to the ram-air flap 5. It is also possible for knob-like or pin-like elevations to be provided on the ram-air flap 5 which then produce an improved connection of the ram-air flap 5 to the plastic of the frame 1.

In one modification, only a partial region of the ram-air flap 5 to be extrusion coated is flexibly designed. A two- or multi-component ram-air flap 5 can be provided, wherein the upper region 20 of the ram-air flap 5 is correspondingly flexible and equipped with a flexible component; and the remaining region 21 of the ram-air flap 5 is equipped with a rigid component. The flexible region 20 constitutes a flexible lip and can consist of an elastomer, silicone, thermoplastic elastomer TPE or a fabric or fabric tape. The rigid region 21 or the rigid component, which assumes approximately ⅘ of the width of the ram-air flap 5, can consist of fiber glass and/or mineral-reinforced plastic. The production of such a subdivided ram-air flap 5 consisting of a flexible region 20 and a rigid region 21 can result from assembly of diverse individual parts or by two-component injection molding or by corresponding extrusion coating or molding. In the embodiments depicted in FIGS. 8 to 11, the flexible element or the flexible region 20 assumes the function of a hinge and thus allows the ram-air flap 5 to deflect in an articulated manner.

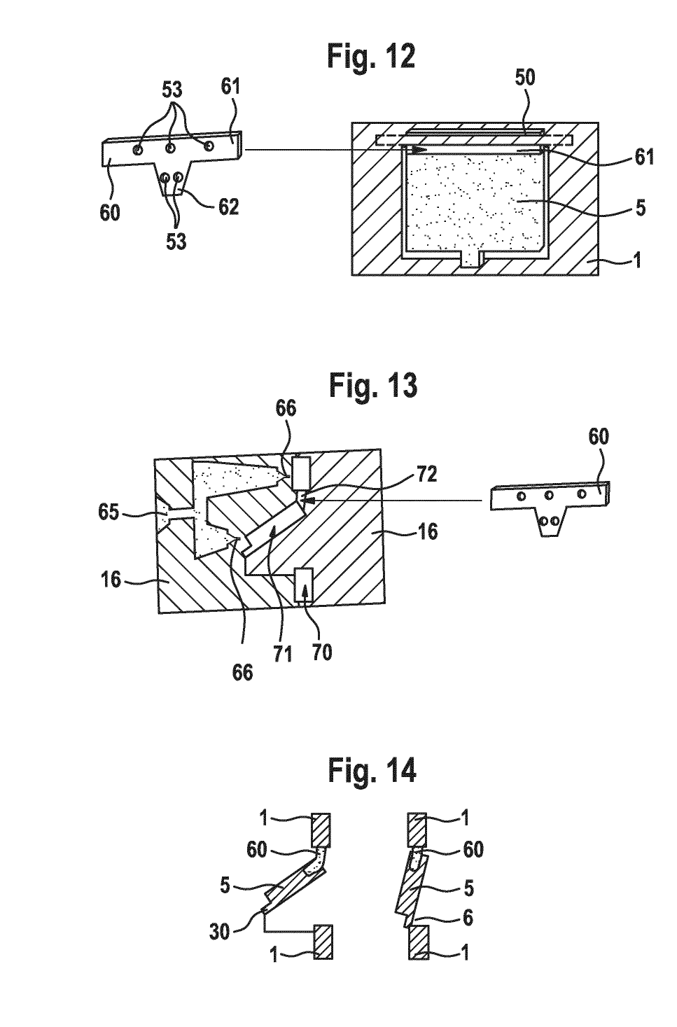

The FIGS. 12 to 14 show a third exemplary embodiment of the method according to the invention, in which all like or similarly operating components are denoted with the same reference numerals of the first and second exemplary embodiments pursuant to FIGS. 1 to 11. Compared to the second exemplary embodiment pursuant to FIGS. 8 to 11, a flexible base element 60 is used instead of the design of the ram-air flap 5 which is flexible at least in certain areas. The base element 60 shown individually in the depiction on the left side in FIG. 12 has the shape of a T comprising a longitudinal element 61 that forms the width of the ram-air flap 5 and a short transverse element 62 at the center of the longitudinal element 61. The flexible base element 60 can consist of elastomer, silicone, thermoplastic elastomer TPE or a fabric or fabric tape. According to the invention, the base element 60 is initially inserted into the injection molding tool 16. Immediately subsequent thereto, the frame 1 and the ram-air flap 5 are molded onto or around the base element 60 in a joint injection molding process or in an injection molding process directly following the frame injection molding process. The base element 60 thereby forms the hinge of the ram-air flap 5 in the frame 1. As in the second exemplary embodiment pursuant to FIGS. 8 to 11, the base element 60 can also be equipped with fastening elements. For example, three fastening elements 53 can be provided in the longitudinal element 61 and two fastening elements 53 in the transverse element 62.

In the depiction on the right side of FIG. 12, the ram-air flap 5 is shown molded to the frame 1 in the finished state. In the depiction on the left side of FIG. 13, the injection molding tool 16 for producing the ram-air flap 5 pursuant to FIG. 12 is shown in detail. The injection molding tool 16 is subdivided and comprises an injection channel in the form of a hot runner comprising at least two nozzles 66. One or a plurality of separate injection points can be filled by means of a hot runner nozzle. It is also possible for provision to be made for one or a plurality of filling channels, by means of which the melt flow is guided from the frame 1 into the ram-air flap 5. The filling channel or the filling channels are subsequently broken out. In a supporting manner, predetermined breaking points introduced in the region of the filling channel can facilitate the separation. The separation can be performed manually or automatically by, for example, an ejector in the tool 16, a third movable tool plate or also by the handling device, which extract the components from the tool 16 which, for example, have also been injection molded.

Two cavity regions 70, 71—a cavity region 70 for the frame 1 and a cavity region 71 for the ram-air flap 5—can be filled by means of the hot runner 65. The region 72 for the flexible base element 60, which partially extends into the cavity region 70 for the frame 1 and into the cavity region 71 for the ram-air flap 5 lies between the cavity region 70 for the frame 1 and the cavity region 71 for the ram-air flap 5. As can be seen in FIG. 13, the cavity region 72 for the flexible base element 60 is designed in a bent manner in order to thus position the associated flexible base element 60, which is depicted on the right side of FIG. 13, likewise in the bent state upon insertion into the tool 16. The cavity region 71 for the base element 60 is however not filled with plastic but is filled by the base element 60 itself and therefore remains free from being extrusion coated. The bent design makes it possible to injection mold the ram-air flap 5 without tool undercuts. As is shown in FIG. 14—a depiction of the fully manufactured ram-air flap 5 in the frame opening or additional opening 6 thereof after removal of the tool 16 in accordance with FIG. 13—, the frame opening or additional opening 6 in the rest position of the ram-air flap 5 is covered as completely as possible by means of the spring-back effect due to the flexible base element 60 and by means of gravity.

The invention is intended for frames 1 having ram-air flaps 5 for engine cooling fans of motor vehicles.

1. A method for producing a frame for an engine cooling fan of a motor vehicle, the frame being equipped with a flap, and produced by means of injection molding plastic in a tool, characterized in that an articulated connection of the flap (5) to the frame (1) is provided in a joint production step for the frame (1), in which the flap (5) is first prepositioned in the tool (16) for production of the frame (1) and then provided cavities (10) of the flap (5) are also filled during the production of the frame (1), which cavities form corresponding bearing points (11) for the flap (5) on the frame (1) after solidification of the plastic and thus enable a movable connection of the flap (5) to the frame (1).

2. The method according to claim 1, characterized in that one of the cavities (10) is provided on each lateral face (7) of the flap (5), each of the cavities being conical in design.

3. The method according to claim 1, characterized in that the flap (5) comprises end faces (8, 9) which are corrugated in design and are pulled flat during positioning in the tool (16).

4. A method for producing a frame for an engine cooling fan of a motor vehicle, the frame being equipped with a flap, and produced by means of injection molding in a tool, characterized in that an articulated connection of the flap (5) to the frame (1) is provided in a joint production step for the frame (1), in which the flap (5) is first prepositioned in the tool (16) for production of the frame (1) and then at least one flexibly configured region (20) of the flap (5) is partially extrusion coated during the production of the frame (1), said region forming a movable hinge connection between the frame (1) and the flap (5).

5. The method according to claim 4, characterized in that the flap (5) is constructed from at least two regions, the flexibly configured region (20) and a rigidly configured region (21).

6. The method according to claim 5, characterized in that the flexibly configured region (20) is produced from an elastomer, silicone or a fabric or a fabric tape.

7. The method according to claim 5, characterized in that the rigidly configured region (21) is produced from at least one of a fiber glass and mineral-reinforced plastic.

8. The method according to claim 4, characterized in that the flexibly configured region (20) is equipped with fastening elements (53).

9. A method for producing a frame for an engine cooling fan of a motor vehicle, the frame being equipped with a flap, and produced by an injection molding process in a tool, characterized in that an articulated connection of the flap (5) to the frame (1) is provided in a joint production step for the frame (1), in which only one flexible base element (60) for the flap (5) is first prepositioned in the tool (16) for production of the frame (1) and then the flexible base element (60) is partially extrusion coated during the production of the frame (1), wherein a remainder of the flap (5) is molded onto the flexible base element (60) at the same time as the injection molding process for the frame (1) or in a further production step, said base element thus enabling a movable hinge connection between the frame (1) and the flap (5) after solidification of the plastic.

10. The method according to claim 9, characterized in that the base element (60) has a T-shape consisting of a longitudinal element (61) and a transverse element (62).

11. The method according to claim 9, characterized in that the flexible base element (60) is produced from an elastomer, silicone or a fabric or a fabric tape.

12. The method according to claim 1, characterized in that different plastics are selected for the production of the frame (1) and for the flap (5), said different plastics preventing the frame and the flap from welding together during the injection molding process.

13. The method according to claim 5, characterized in that the flexibly configured region (20) is produced from a thermoplastic elastomer, silicone or a fabric or a fabric tape.

14. The method according to claim 9, characterized in that the flexible base element (60) is produced from a thermoplastic elastomer, silicone or a fabric or a fabric tape.

15. The method according to claim 4, characterized in that different plastics are selected for the production of the frame (1) and for the flap (5), said different plastics preventing the frame and the flap from welding together during the injection molding process.

16. The method according to claim 9, characterized in that different plastics are selected for the production of the frame (1) and for the flap (5), said different plastics preventing the frame and the flap from welding together during the injection molding process.
